(19) United States
(12) Patent Application Publication
(10) Pub. No.: US 2022/0399828 A1
(43) Pub. Date: Dec. 15, 2022

(54) DIRECT-CURRENT POWER SUPPLY, REFRIGERATION CYCLER, AIR CONDITIONER, AND REFRIGERATOR

(71) Applicant: Mitsubishi Electric Corporation, Tokyo (JP)

(72) Inventors: Koyo SHIMIZU, Tokyo (JP); Shinichiro URA, Tokyo (JP); Takuto YAMASHITA, Tokyo (JP); Keisuke UEMURA, Tokyo (JP)

(21) Appl. No.: 17/776,736

(22) PCT Filed: Feb. 20, 2020
(86) PCT No.: PCT/JP2020/006891

§ 371 Date: May 13, 2022

(51) Int. Cl. H02M 7/219; F25B 31/02

(52) U.S. Cl. CPC H02M 7/219; F25B 31/026; H02P 27/06

(57) ABSTRACT

A direct-current power supply includes: a rectifier circuit in which switching elements are bridge-connected; a reactor; a gate circuitry that drives the switching elements; and a gate circuitry that drives the switching elements. A connection point between the switching element and the switching element is connected to an alternating-current power supply via the reactor, and a connection point between the switching element and the switching element is connected to the alternating-current power supply without via the reactor. A time during which the gate circuitry turns on the switching elements is longer than a time during which the gate circuitry turns on the switching elements.

### FIELD

The present disclosure relates to a direct-current power supply including a diode bridge-less (DBL) rectifier circuit, a refrigeration cycler including the direct-current power supply, and an air conditioner and a refrigerator equipped with the refrigeration cycler.

### BACKGROUND

As a conventional technique related to a direct-current power supply including a DBL rectifier circuit, there is a technique described in Patent Literature 1 below. This Patent Literature 1 discloses a technique for protecting a switching element included in a DBL rectifier circuit even when there is disturbance of a power supply voltage such as a lightning surge.

### CITATION LIST

### Patent Literature

Patent Literature 1: WO 2019/082246 A

### SUMMARY

### Technical Problem

Patent Literature 1 describes that a recovery current can flow through a switching element due to disturbance of a power supply voltage. However, in Patent Literature 1, no consideration is given to ringing noise that can be generated by the recovery current. Therefore, the technique of Patent Literature 1 cannot suppress this ringing noise.

The present disclosure has been made in view of the above, and an object is to obtain a direct-current power supply capable of suppressing ringing noise that may be caused by a recovery current.

### Solution to Problem

In order to solve the above-described problem and to achieve the object, a direct-current power supply according to the present disclosure includes: a rectifier circuit in which first to fourth switching elements are bridge-connected; and a reactor connected between an alternating-current power supply and the rectifier circuit. Further, the direct-current power supply includes a first gate circuitry that drives the first and second switching elements, and a second gate circuitry that drives the third and fourth switching elements. A connection point between the first switching element and the second switching element is connected to the alternating-current power supply via the reactor. A connection point between the third switching element and the fourth switching element is connected to the alternating-current power supply without via the reactor. A time during which the first gate circuitry turns on the first switching element is longer than a time during which the second gate circuitry turns on the third and fourth switching elements. Further, a time during which the first gate circuitry turns on the second switching element is longer than a time during which the second gate circuitry turns on the third and fourth switching elements.

### Advantageous Effects of Invention

According to the direct-current power supply of the present disclosure, it is possible to provide an effect of suppressing ringing noise that may be generated by a recovery current.

### BRIEF DESCRIPTION OF DRAWINGS

FIG. 1 is a diagram illustrating a configuration example of a direct-current power supply according to a first embodiment.

FIG. 2 is a diagram illustrating an internal configuration example of a gate circuitry illustrated in FIG. 1.

FIG. 3 is a diagram illustrating a first current path flowing through a general MOSFET.

FIG. 4 is a diagram illustrating a second current path flowing through a general MOSFET.

FIG. 5 is a diagram illustrating a first current path flowing through a rectifier circuit according to the first embodiment.

FIG. 6 is a diagram illustrating a second current path flowing through the rectifier circuit according to the first embodiment.

FIG. 7 is a diagram illustrating a third current path flowing through the rectifier circuit according to the first embodiment.

FIG. 8 is a diagram illustrating a fourth current path flowing through the rectifier circuit according to the first embodiment.

FIG. 9 is a diagram illustrating a fifth current path flowing through the rectifier circuit according to the first embodiment.

FIG. 10 is a diagram illustrating a sixth current path flowing through the rectifier circuit according to the first embodiment.

FIG. 11 is a diagram illustrating an operation waveform and an operation state of a main part in the direct-current power supply according to the first embodiment.

FIG. 12 is a diagram illustrating a path of a recovery current that may flow in accordance with a first operation transition in the rectifier circuit according to the first embodiment.

FIG. 13 is a diagram illustrating a path of a recovery current that may flow in accordance with a second operation transition in the rectifier circuit according to the first embodiment.

FIG. 14 is a view illustrating a waveform of a main part when ringing occurs in a switching element in the rectifier circuit according to the first embodiment.

FIG. 15 is a diagram illustrating a configuration example of a refrigeration cycler according to a second embodiment.

### DESCRIPTION OF EMBODIMENTS

### First Embodiment

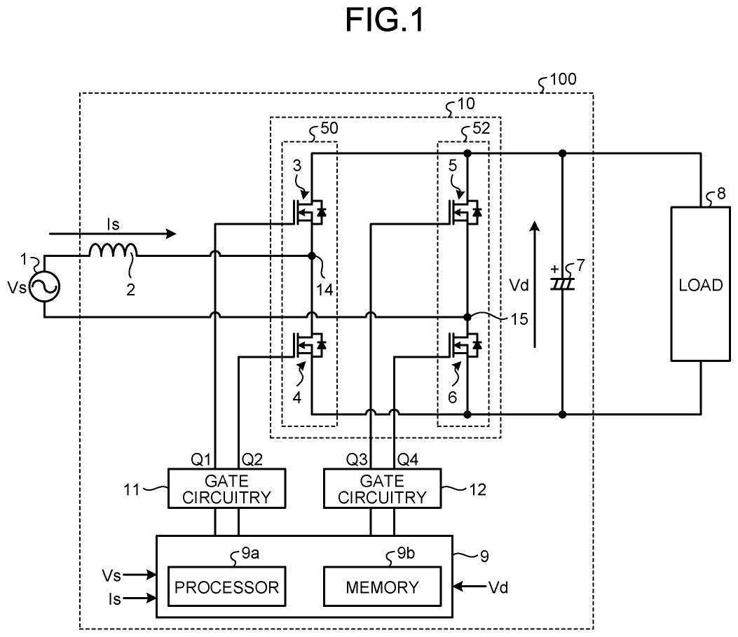

FIG. 1 is a diagram illustrating a configuration example of a direct-current power supply 100 according to a first embodiment. The direct-current power supply 100 according to the first embodiment is a power supply that converts alternating current supplied from an alternating-current power supply 1 into a direct current, and supplies to a load 8. As illustrated in FIG. 1, the direct-current power supply 100 includes a reactor 2, a rectifier circuit 10, a smoothing capacitor 7, a gate circuitry 11 which is a first gate circuitry, a gate circuitry 12 which is a second gate circuitry, and a controller 9.

The rectifier circuit 10 of the first embodiment is a DBL rectifier circuit. A general rectifier circuit has a configuration in which four diodes are bridge-connected. On the other hand, the DBL rectifier circuit has a configuration in which four switching elements are bridge-connected. That is, in the DBL rectifier circuit, each of the four diodes is replaced with a switching element.

The rectifier circuit 10 includes a first leg 50 and a second leg 52 connected in parallel to the first leg 50. The first leg 50 includes a switching element 3 which is a first switching element, and a switching element 4 which is a second switching element. The switching element 3 and the switching element 4 are connected in series. The second leg 52 includes a switching element 5 which is a third switching element, and a switching element 6 which is a fourth switching element. The switching element 5 and the switching element 6 are connected in series.

In FIG. 1, a diode is connected to each of the switching elements 3, 4, 5, and 6 in parallel. An example of the switching elements 3, 4, 5, and 6 is an illustrated metal oxide semiconductor field effect transistor (MOSFET). In a case where the MOSFET is used for the switching elements 3, 4, 5, and 6, a parasitic diode exists inside of each of the elements. For this reason, in a case where the MOSFET is used, diodes connected in parallel can be omitted by using the parasitic diode.

The MOSFET is generally a bidirectional element capable of allowing a current to bidirectionally flow, unlike a unidirectional element such as a diode that allows a current to flow only in one direction. That is, when a charge is supplied to a gate of the MOSFET in order to control the MOSFET to be turned on, a current can also flow in an opposite direction. Note that the opposite direction here means a direction opposite to a direction of a current flowing in the parasitic diode built in the MOSFET.

The reactor 2 is connected between the alternating-current power supply 1 and the rectifier circuit 10. Specifically, one end of the reactor 2 is connected to one side of the alternating-current power supply 1, and another end of the reactor 2 is connected to a connection point 14, which is a connection point between the switching element 3 and the switching element 4. A connection point 15, which is a connection point between the switching element 5 and the switching element 6, is connected to another side of the alternating-current power supply 1. The connection points 14 and 15 constitute input terminals of the rectifier circuit 10. That is, the connection point 14 is an input end of the rectifier circuit 10 connected via the reactor 2, and the connection point 15 is an input end of the rectifier circuit 10 connected without the reactor 2.

Between output terminals of the rectifier circuit 10, the smoothing capacitor 7 is connected. The rectifier circuit 10 converts a power supply voltage Vs applied from the alternating-current power supply 1 via the reactor 2 into a direct-current voltage. The power supply voltage Vs is an alternating-current voltage outputted from the alternating-current power supply 1.

The smoothing capacitor 7 is charged by an output of the rectifier circuit 10. The smoothing capacitor 7 smooths a direct-current voltage outputted from the rectifier circuit 10. To both ends of the smoothing capacitor 7, the load 8 is connected. The load 8 includes an inverter that operates using power of the smoothing capacitor 7, a motor that is driven by the inverter, and equipment driven by the motor.

The controller 9 includes a processor 9a and a memory 9b. To the controller 9, each of detection values of the power supply voltage Vs, a circuit current Is, and a capacitor voltage Vd is inputted. The circuit current Is is a current flowing to the rectifier circuit 10 via the reactor 2. The circuit current may also be referred to as a “primary current”. The capacitor voltage Vd is a voltage of the smoothing capacitor 7. The capacitor voltage may also be referred to as a “bus-bar voltage”. Each of the power supply voltage Vs, the circuit current Is, and the capacitor voltage Vd is detected by a detector not illustrated in FIG. 1.

The controller 9 generates a control signal for controlling conduction of the switching elements 3 and 4 on the basis of the individual detection values of the power supply voltage Vs, the circuit current Is, and the capacitor voltage Vd, and outputs the control signal to the gate circuitry 11. In addition, the controller 9 generates a control signal for controlling conduction of the switching elements 5 and 6 on the basis of the individual detection values of the power supply voltage Vs, the circuit current Is, and the capacitor voltage Vd, and outputs the control signal to the gate circuitry 12.

The gate circuitry 11 generates and outputs gate signals Q1 and Q2 for driving the switching elements 3 and 4, on the basis of the control signal outputted from the controller 9. The gate signal Q1 is a signal for controlling a conduction state of the switching element 3 from on to off or from off to on. The gate signal Q2 is a signal for controlling a conduction state of the switching element 4 from on to off or from off to on.

The gate circuitry 12 generates and outputs gate signals Q3 and Q4 for driving the switching elements 5 and 6, on the basis of the control signal outputted from the controller 9. The gate signal Q3 is a signal for controlling a conduction state of the switching element 5 from on to off or from off to on. The gate signal Q4 is a signal for controlling a conduction state of the switching element 6 from on to off or from off to on.

When the switching elements 3, 4, 5, and 6 are driven, the gate signals Q1 to Q4: are converted into voltage levels that allow driving of the switching elements 3, 4, 5, and 6; and are outputted. The gate circuitries 11 and 12 can be implemented by using a level shift circuit or the like.

In the controller 9, the processor 9a is an arithmetic means such as an arithmetic device, a microprocessor, a microcomputer, a central processing unit (CPU), or a digital signal processor (DSP). The memory 9b is a nonvolatile or volatile semiconductor memory such as a random access memory (RAM), a read only memory (ROM), a flash memory, an erasable programmable ROM (EPROM), or an electrically EPROM (EEPROM, registered trademark).

The memory 9b stores a program for executing a function of the controller 9. The processor 9a exchanges necessary information via an interface including an analog/digital converter and a digital/analog converter (not illustrated), and the processor 9a executes a program stored in the memory 9b to perform required processing. An arithmetic result by the processor 9a is stored in the memory 9b.

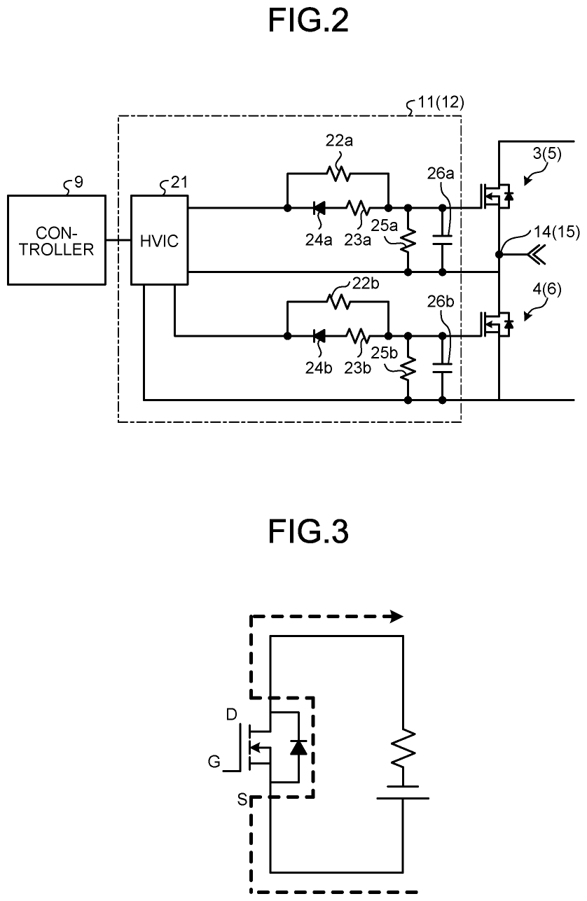

FIG. 2 is a diagram illustrating an internal configuration example of the gate circuitry 11 illustrated in FIG. 1. The gate circuitry 12 has a configuration similar to the gate circuitry 11. In FIG. 2, reference numerals of components corresponding to the gate circuitry 12 are shown in parentheses. Note that the gate circuitry 11 and the gate circuitry 12 have circuit constants that are partially different from each other. A difference between the two will be described later. Hereinafter, the gate circuitry 11 will be described.

As illustrated in FIG. 2, the gate circuitry 11 includes: gate-on resistors 22a and 22b; gate-off resistors 23a and 23b; resistors 25a and 25b; diodes 24a and 24b; capacitors 26a and 26b; and a high voltage integrated circuit (HVIC) 21. The HVIC 21 is a high withstand voltage IC that outputs a gate signal for driving gates of the switching elements 3 and 4 in accordance with an input signal from the controller 9.

In the configuration of FIG. 2, when the switching element 3 is controlled from off to on, a charge is supplied to the gate via the gate-on resistor 22a. When the switching element 3 is controlled from on to off, charges accumulated in the gate are discharged via the gate-off resistor 23a. This function of gate-on and gate-off, that is, switching of a signal transmission path, is implemented by the diode 24a, which is a unidirectional element. The capacitor 26a constitutes an RC circuit together with the gate-on resistor 22a, the gate-off resistor 23a, and the resistor 25a.

In addition, when the switching element 4 is controlled from off to on, a charge is supplied to the gate via the gate-on resistor 22b. When the switching element 4 is controlled from on to off, charges accumulated in the gate are discharged via the gate-off resistor 23b. This function of gate-on and gate-off, that is, switching of a signal transmission path, is implemented by the diode 24b, which is a unidirectional element. The capacitor 26b constitutes an RC circuit together with the gate-on resistor 22b, the gate-off resistor 23b, and the resistor 25b.

As described above, the gate circuitries 11 and 12 according to the first embodiment are configured to individually include a gate-on resistor for gate-on and a gate-off resistor for gate-off of a switching element to be driven.

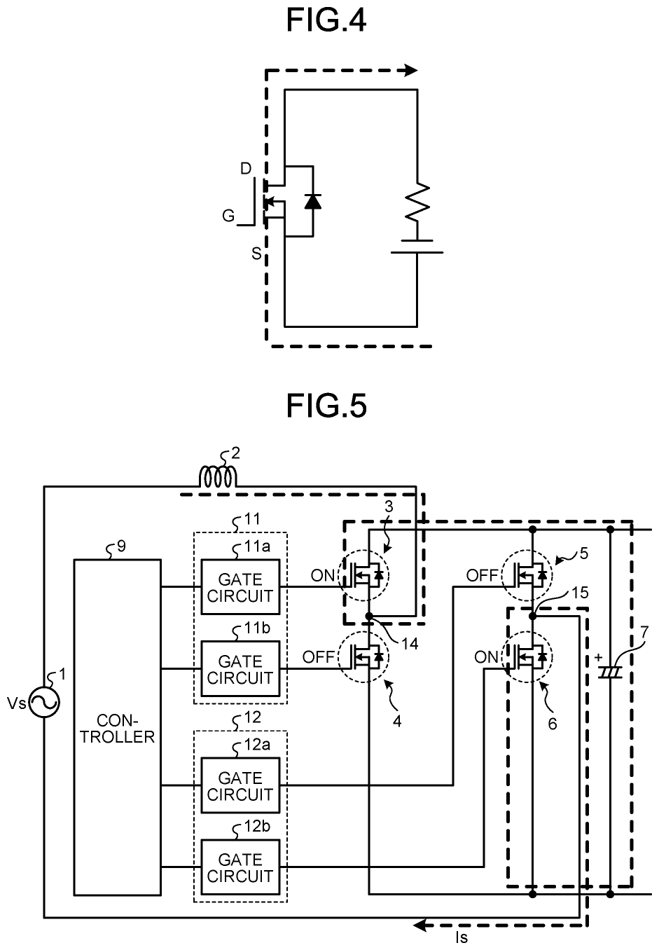

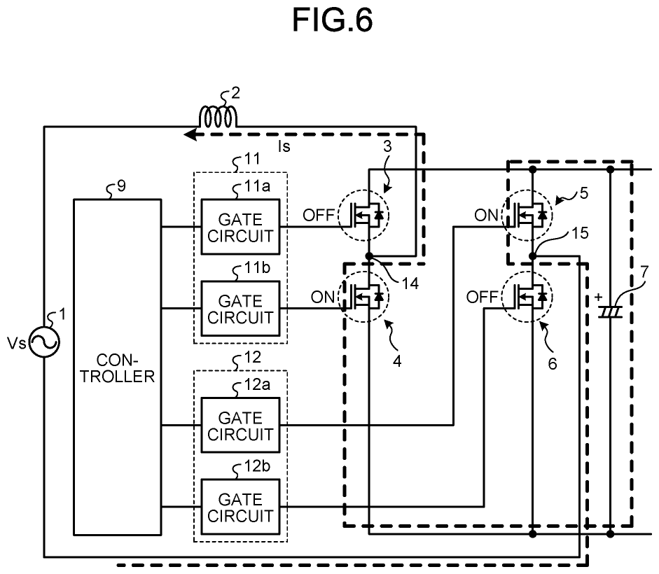

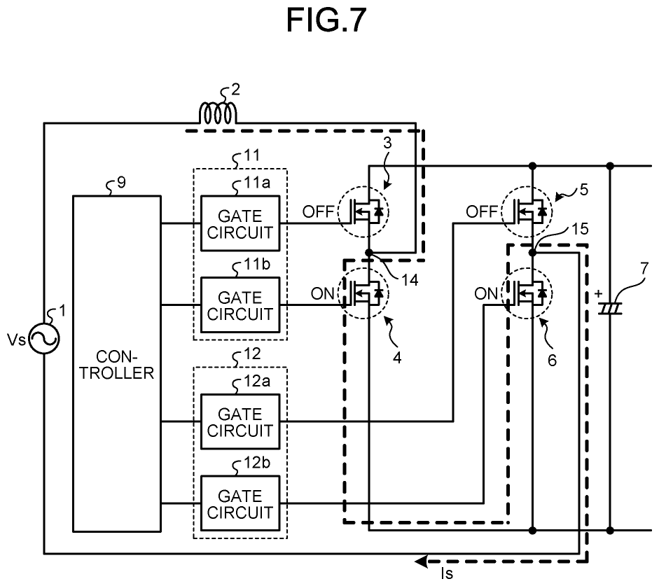

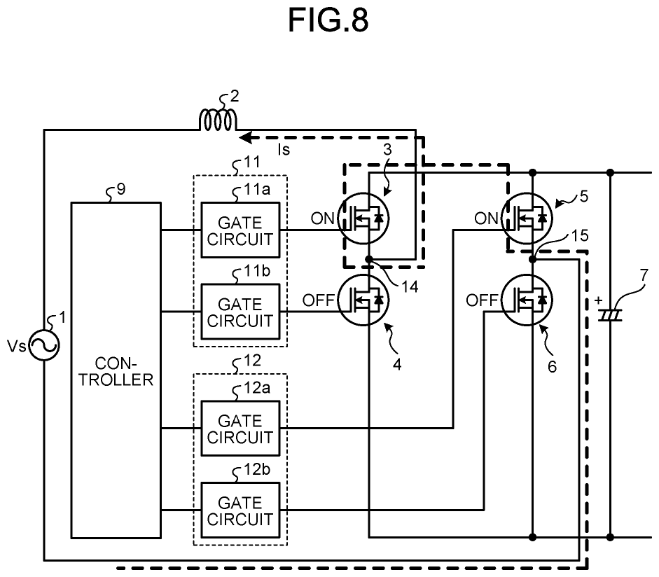

Next, a basic operation of the direct-current power supply 100 according to the first embodiment will be described with reference to FIGS. 3 to 8. FIG. 3 is a diagram illustrating a first current path flowing through a general MOSFET. FIG. 4 is a diagram illustrating a second current path flowing through a general MOSFET. FIG. 5 is a diagram illustrating a first current path flowing through the rectifier circuit 10 according to the first embodiment. FIG. 6 is a diagram illustrating a second current path flowing through the rectifier circuit 10 according to the first embodiment. FIG. 7 is a diagram illustrating a third current path flowing through the rectifier circuit 10 according to the first embodiment. FIG. 8 is a diagram illustrating a fourth current path flowing through the rectifier circuit 10 according to the first embodiment.

In FIGS. 3 and 4, a voltage is applied to the MOSFET such that a source side is positive. FIG. 3 illustrates a state in which the MOSFET is in a gate-off state, that is, a state in which no voltage is applied between a gate and a source of the MOSFET. In this case, a current via a parasitic diode of the MOSFET as indicated by a broken line in FIG. 3 flows through the MOSFET.

In addition, FIG. 4 illustrates a state in which the MOSFET is in a gate-on state, that is, a state in which a voltage is applied between the gate and the source of the MOSFET and the MOSFET is turned on. In this on state, in a case where a voltage drop due to on-resistance of the MOSFET is lower than a forward voltage of the parasitic diode, a current flows through a transistor of the MOSFET, that is, a channel of the MOSFET. In this case, a conduction loss due to the on-resistance of the MOSFET is smaller than a conduction loss when a current flows through a diode. In this way, a technology of reducing a conduction loss by causing a current to flow through the transistor of a MOSFET instead of a diode is “synchronous rectification”.

In the circuit configuration illustrated in FIG. 1, when all of the switching elements 3, 4, 5, and 6, which are MOSFETs, are in a gate-off state, the rectifier circuit 10 performs a full-wave rectification operation via the parasitic diodes of the MOSFETs. In the case of the full-wave rectification operation, it is also possible to operate by using a diode instead of the MOSFET. Whereas, the switching element is used instead of the diode in the first embodiment. This is for reducing a conduction loss by performing the synchronous rectification described above.

In the direct-current power supply 100 of the first embodiment, a synchronous rectification operation and a boosting operation by switching control are performed.

As illustrated in FIGS. 5 to 8, the gate circuitry 11 includes a gate circuit 11a which is a first gate circuit, and a gate circuit 11b which is a second gate circuit. The gate circuit 11a is a gate circuit that drives the switching element 3, and the gate circuit 11b is a gate circuit that drives the switching element 4. Referring to FIG. 2, the HVIC 21, the gate-on resistor 22a, the gate-off resistor 23a, the resistor 25a, the diode 24a, and the capacitor 26a constitute the gate circuit 11a. Further, the HVIC 21, the gate-on resistor 22b, the gate-off resistor 23b, the resistor 25b, the diode 24b, and the capacitor 26b constitute the gate circuit 11b.

Further, the gate circuitry 12 includes a gate circuit 12a which is a third gate circuit, and a gate circuit 12b which is a fourth gate circuit. The gate circuit 12a is a gate circuit that drives the switching element 5, and the gate circuit 12b is a gate circuit that drives the switching element 6. Referring to FIG. 2, the HVIC 21, the gate-on resistor 22a, the gate-off resistor 23a, the resistor 25a, the diode 24a, and the capacitor 26a constitute the gate circuit 12a. Further, the HVIC 21, the gate-on resistor 22b, the gate-off resistor 23b, the resistor 25b, the diode 24b, and the capacitor 26b constitute the gate circuit 12b.

FIG. 5 illustrates the circuit current Is by full-wave rectification when the power supply voltage Vs is positive. The switching elements 3 and 6 are in a gate-on state, and the switching elements 4 and 5 are in a gate-off state. In this state, the circuit current Is flows through a path of the alternating-current power supply 1, the reactor 2, the switching element 3, the smoothing capacitor 7, the switching element 6, and the alternating-current power supply 1. In order to reduce a conduction loss during the full-wave rectification, control is performed such that a current flows through the transistor instead of the parasitic diode of the switching elements 3 and 6. This control is the synchronous rectification described above.

FIG. 6 illustrates the circuit current Is by full-wave rectification when the power supply voltage Vs is negative. The switching elements 4 and 5 are in a gate-on state, and the switching elements 3 and 6 are in a gate-off state. In this state, the circuit current Is flows through a path of the alternating-current power supply 1, the switching element 5, the smoothing capacitor 7, the switching element 4, the reactor 2, and the alternating-current power supply 1. Also in this full-wave rectification, in order to reduce the conduction loss, synchronous rectification is performed such that a current flows through the transistor instead of the parasitic diode of the switching elements 4 and 5.

Next, the boosting operation will be described. In the boosting operation in the first embodiment, switching control is performed on the switching elements 3 and 4 at a certain switching frequency to cause a short-circuit current to flow in the rectifier circuit 10, thereby boosting the capacitor voltage Vd and improving a power factor. Note that the switching elements 5 and 6 are subjected to switching control every half cycle of a power supply cycle. The power supply cycle is a cycle of the power supply voltage Vs. That is, the switching elements 3 and 4 are subjected to switching control at a higher speed than the switching elements 5 and 6.

FIG. 7 illustrates the circuit current Is by a switching operation when the power supply voltage Vs is positive. The switching elements 4 and 6 are in a gate-on state, and the switching elements 3 and 5 are in a gate-off state. In this state, the circuit current Is flows through a path of the alternating-current power supply 1, the reactor 2, the switching element 4, the switching element 6, and the alternating-current power supply 1. Since the circuit current Is at this time flows without via the smoothing capacitor 7, it is also called a “short-circuit current”. By the current in this path, energy is stored in the reactor 2. Then, when switching is made to the current path of FIG. 5 by a switching operation immediately after, the energy stored in the reactor 2 is released to the smoothing capacitor 7. As a result, the capacitor voltage Vd is boosted.

FIG. 8 illustrates the circuit current Is by a switching operation when the power supply voltage Vs is negative. The switching elements 3 and 5 are in a gate-on state, and the switching elements 4 and 6 are in a gate-off state. In this state, the circuit current Is flows through a path of the alternating-current power supply 1, the switching element 5, the switching element 3, the reactor 2, and the alternating-current power supply 1. The circuit current Is at this time is also referred to as a “short-circuit current”. By the current in this path, energy is stored in the reactor 2. Then, when switching is made to the current path of FIG. 6 by a switching operation immediately after, the energy stored in the reactor 2 is released to the smoothing capacitor 7. As a result, the capacitor voltage Vd is boosted.

In the direct-current power supply 100 of the first embodiment, the above described synchronous rectification operation and boosting operation are repeated as a basic operation. As a result, the capacitor voltage Vd is boosted.

Next, ringing noise that may occur in the direct-current power supply 100 will be described.

First, the basic operation of the direct-current power supply 100 has been described above. Whereas, in actual control, when switching operations of the switching elements 3, 4, 5, and 6 are switched, a dead time is provided so that the switching elements of the same leg are not turned on at the same time. For example, in a case where the switching element 3 and the switching element 4 are turned on at the same time, the first leg 50 is short-circuited through these switching elements, charges stored in the smoothing capacitor 7 are released, and a large current flows through the switching elements 3 and 4. This large current may damage the switching elements 3 and 4. The dead time is provided to prevent this type of damage. A similar countermeasure is taken for the switching elements 5 and 6.

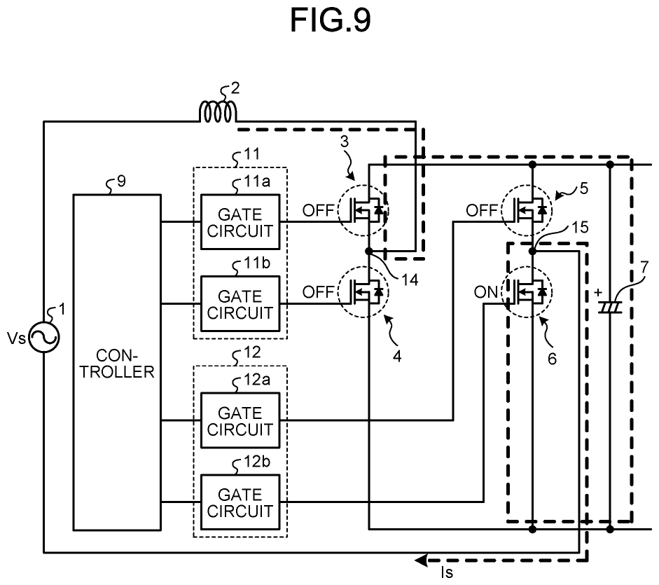

FIG. 9 is a diagram illustrating a fifth current path flowing through the rectifier circuit 10 according to the first embodiment. FIG. 9 illustrates the circuit current Is flowing when the switching elements 3 and 4 are simultaneously turned off when the power supply voltage Vs is positive, the switching element 5 is turned off, and the switching element 6 is turned on. The simultaneous turn-off of the switching elements 3 and 4 occurs during a dead time period.

In FIG. 9, a current path through which the circuit current Is flows is the identical to that in FIG. 5, but a portion through which the current flows is different in the switching element 3. Specifically, the circuit current Is does not flow via the transistor of the switching element 3, but flows via the parasitic diode of the switching element 3. In this way, since the current path through the parasitic diode can be used, it is possible to provide a dead time for simultaneously turning off the switching elements 3 and 4, which are two switching elements of the same leg.

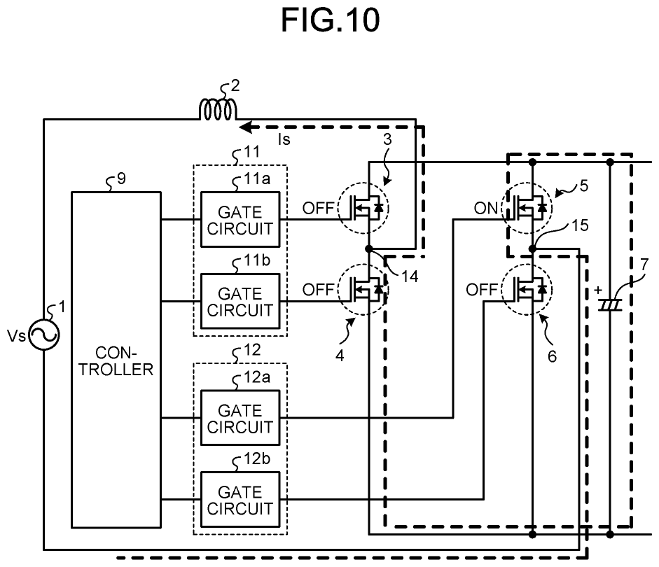

FIG. 10 is a diagram illustrating a sixth current path flowing through the rectifier circuit 10 according to the first embodiment. FIG. 10 illustrates the circuit current Is flowing when the switching elements 3 and 4 are simultaneously turned off when the power supply voltage Vs is negative, the switching element 5 is turned on, and the switching element 6 is turned off. When the power supply voltage Vs is negative as well, the simultaneous turn-off of the switching elements 3 and 4 occurs during a dead time period.

In FIG. 10, a current path through which the circuit current Is flows is the identical to that in FIG. 6, but a portion through which the current flows is different in the switching element 4. Specifically, the circuit current Is does not flow via the transistor of the switching element 4, but flows via the parasitic diode of the switching element 4. In this way, since the current path through the parasitic diode can be used, it is possible to provide a dead time for simultaneously turning off the switching elements 3 and 4, which are two switching elements of the same leg when the power supply voltage Vs is negative as well.

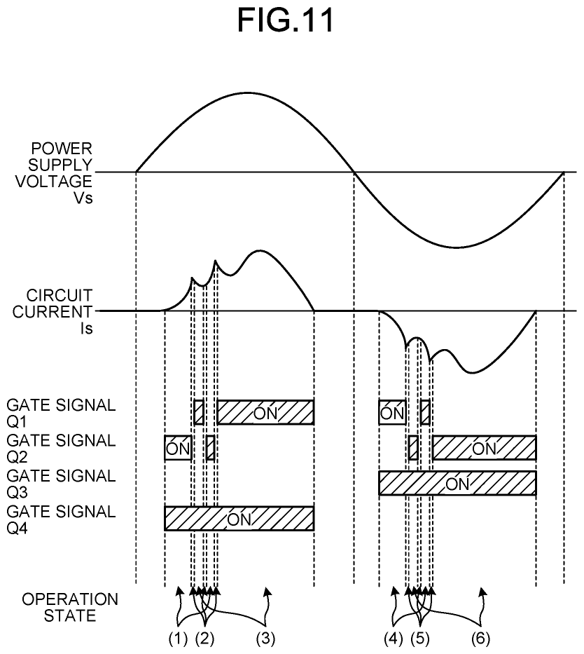

FIG. 11 is a diagram illustrating an operation waveform and an operation state of a main part in the direct-current power supply 100 according to the first embodiment. A horizontal axis in FIG. 11 represents time.

FIG. 11 illustrates an operation waveform when the above-described boosting operation is executed twice every half cycle of the power supply voltage Vs. The power supply voltage Vs, the circuit current Is, the gate signals Q1 to Q4, and operation states of the rectifier circuit 10 are illustrated in order from an upper side of FIG. 11. In the gate signals Q1 to Q4, periods during which the individual switching elements are turned on are indicated by hatching.

Further, as illustrated in FIG. 11, the operation states of the rectifier circuit 10 are represented by numerical values of (1) to (6). Specifically, (1), (2), (3), (4), (5), and (6) correspond to FIGS. 7, 9, 5, 8, 10, and 6, respectively, and each operation is executed in a period sandwiched by corresponding two broken lines. In the following description, the operation state of the rectifier circuit 10 is represented by any one of the numerical values (1) to (6).

The operation state at the time of boosting when the power supply voltage Vs is positive transitions in the order of (1)→(2)→(3)→(2)→(1)→(2)→(3). Ringing noise occurs in an operation transition of (2)→(1) during these operation transitions. Hereinafter, the operation transition when the operation state is (2)→(1) is appropriately referred to as a “first operation transition”.

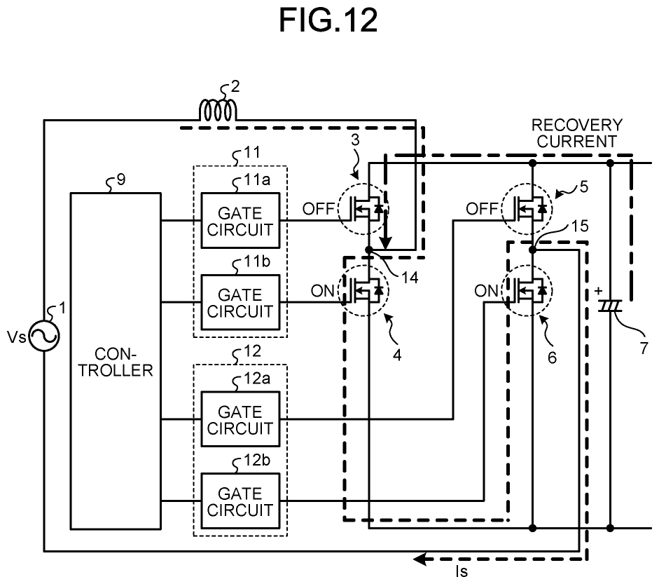

Next, a generation principle of the ringing noise will be described. FIG. 12 is a diagram illustrating a path of a recovery current that may flow in accordance with the first operation transition in the rectifier circuit 10 according to the first embodiment. As described above, according to the first operation transition, the operation state of the rectifier circuit 10 transitions from (2) to (1). As illustrated in FIG. 9, (2) is the dead time period, and the circuit current Is flows via the parasitic diode of the switching element 3. When this state transitions to the state (1), the circuit current Is starts flowing to the switching element 4, and the parasitic diode of the switching element 3 enters a reverse recovery time. At this time, as illustrated in FIG. 12, a recovery current flows from the smoothing capacitor 7 toward the parasitic diode of the switching element 3. As a result, a drain-source voltage Vds of the switching element 3 rapidly increases, and ringing occurs in the switching element 3.

Further, the operation state at the time of boosting when the power supply voltage Vs is negative transitions in the order of (4)→(5)→(6)→(5)→(4)→(5)→(6). Ringing noise occurs in an operation transition of (5)→(4) during these operation transitions. Hereinafter, the operation transition when the operation state is (5)→(4) is appropriately referred to as a “second operation transition”.

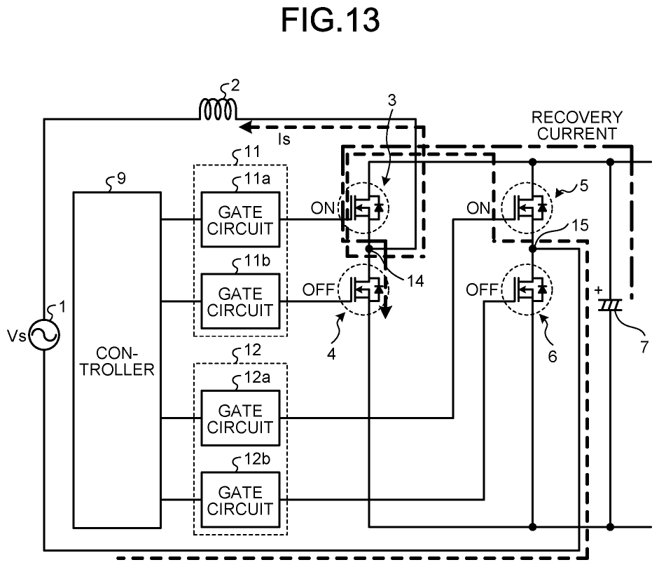

FIG. 13 is a diagram illustrating a path of a recovery current that may flow in accordance with the second operation transition in the rectifier circuit 10 according to the first embodiment. As described above, according to the second operation transition, the operation state of the rectifier circuit 10 transitions from (5) to (4). As illustrated in FIG. 10, (5) is the dead time period, and the circuit current Is flows via the parasitic diode of the switching element 4. When this state transitions to the state (4), the circuit current Is starts flowing to the switching element 3, and the parasitic diode of the switching element 4 enters a reverse recovery time. At this time, as illustrated in FIG. 13, a recovery current flows from the smoothing capacitor 7 toward the parasitic diode of the switching element 4. As a result, a drain-source voltage Vds of the switching element 4 rapidly increases, and ringing occurs in the switching element 4.

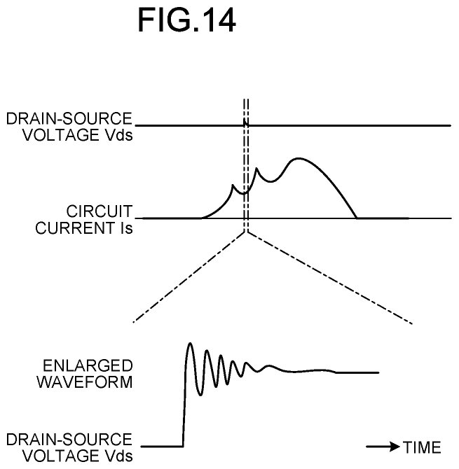

FIG. 14 is a view illustrating a waveform of a main part when ringing occurs in the switching element 3 in the rectifier circuit 10 according to the first embodiment. A horizontal axis represents time. An upper part of FIG. 14 illustrates waveforms of the drain-source voltage Vds and the circuit current Is during the boosting operation of the switching element 3. In addition, in a lower part of FIG. 11, an enlarged waveform of a section sandwiched by one dotted chain lines is illustrated.

As illustrated in FIG. 14, ringing noise appears in the drain-source voltage Vds. As can be understood from comparison between FIGS. 14 and 11, this ringing noise occurs in the first operation transition, that is, when the operation state becomes (2)→(1).

FIG. 14 illustrates an example at a time of switching twice in which the boosting operation is repeated twice. However, in a case of high-speed switching in which the boosting operation is repeated at a cycle faster than twice, an influence of the ringing noise appears more remarkably than the switching performed twice.

The ringing noise occurs in the switching element on the side where switching is made at a time of boosting. In the case of the example of the first embodiment, the ringing noise occurs in the switching elements 3 and 4. Therefore, the ringing noise can be reduced by lowering dV/dt of the drain-source voltage Vds when the switching elements 3 and 4 are turned on.

In the case of the first operation transition, by lowering dV/dt of the drain-source voltage Vds when the switching element 4 is turned on, it is possible to suppress a rapid rise in the drain-source voltage Vds of the switching element 3. Note that lowering dV/dt of the drain-source voltage Vds of the switching element 3 is equivalent to lengthening a turn-on time of the switching element 4 as compared with a turn-on time of the switching elements 5 and 6.

In the case of the second operation transition, that is, the operation state is (5)→(4), by lowering dV/dt of the drain-source voltage Vds when the switching element 3 is turned on, it is possible to suppress a rapid rise in the drain-source voltage Vds of the switching element 4. Note that lowering dV/dt of the drain-source voltage Vds of the switching element 4 is equivalent to lengthening a turn-on time of the switching element 3 as compared with a turn-on time of the switching elements 5 and 6.

In order to lengthen the turn-on time of each of the switching elements 3 and 4 as compared with the turn-on time of each of the switching elements 5 and 6, in the first embodiment, circuit constants are made partially different between the gate circuitry 11 and the gate circuitry 12. Specifically, it is as follows.

First, in order to lengthen the turn-on time of the switching element 3 as compared with the turn-on time of the switching elements 5 and 6, the gate-on resistor 22a of the gate circuit 11a has a resistance value larger than that of the gate-on resistor 22a of the gate circuit 12a and the gate-on resistor 22b of the gate circuit 12b. Similarly, in order to lengthen the turn-on time of the switching element 4 as compared with the turn-on time of the switching elements 5 and 6, the gate-on resistor 22b of the gate circuit 11b has a resistance value larger than that of the gate-on resistor 22a of the gate circuit 12a and the gate-on resistor 22b of the gate circuit 12b.

Here, the resistance value of the gate-on resistor 22a of the gate circuit 11a is defined as Ra, the resistance value of the gate-on resistor 22b of the gate circuit 11b is defined as Rb, the resistance value of the gate-on resistor 22a of the gate circuit 12a is defined as Ra′, and the resistance value of the gate-on resistor 22b of the gate circuit 12b is defined as Rb′. When the definition is made in this way, relations of Ra>Ra′, Ra>Rb′, Rb>Ra′, and Rb>Rb′ are established among these Ra, Ra′, Rb, and Rb′.

By setting as described above, it is possible to reduce the ringing noise that occurs in the switching element on the side where switching is made at the time of boosting, that is, on the side of the switching element performing high-speed switching.

As described above, the direct-current power supply according to the first embodiment includes: the rectifier circuit in which the first to fourth switching elements are bridge-connected; the first gate circuitry that drives the first and second switching elements; and the second gate circuitry that drives the third and fourth switching elements. The connection point between the first switching element and the second switching element is connected to the alternating-current power supply via the reactor, and the connection point between the third switching element and the fourth switching element is connected to the alternating-current power supply without via the reactor. The time during which the first gate circuitry turns on the first switching element is set longer than the time during which the second gate circuitry turns on the third and fourth switching elements. Further, the time during which the first gate circuitry turns on the second switching element is set longer than the time during which the second gate circuitry turns on the third and fourth switching elements. As a result, it is possible to suppress ringing noise that may occur in the first and second switching elements due to a recovery current.

Note that, in the first embodiment, the connection point 14 between the switching elements 3 and 4 is connected to the alternating-current power supply 1 via the reactor 2, and the connection point 15 between the switching elements 5 and 6 is connected to the alternating-current power supply 1 without the reactor 2, but the present disclosure is not limited thereto. A configuration may be adopted in which the connection point 14 between the switching elements 3 and 4 is connected to the alternating-current power supply 1 without via the reactor 2, and the connection point 15 between the switching elements 5 and 6 is connected to the alternating-current power supply 1 via the reactor 2. Note that, in a case of this configuration, the switching elements 5 and 6 are subjected to switching control at a higher speed than the switching elements 3 and 4.

### Second Embodiment

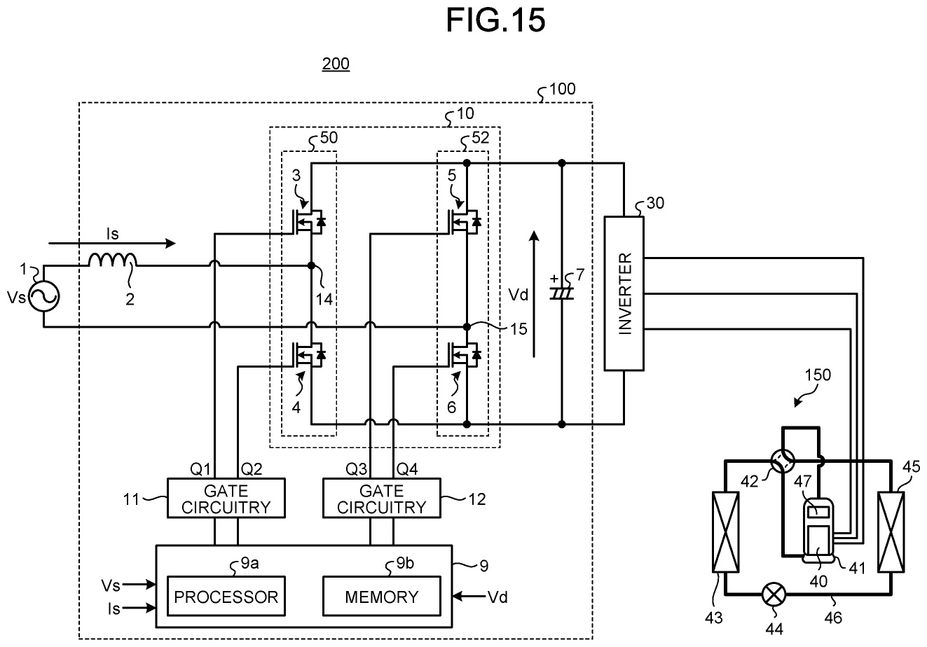

FIG. 15 is a view illustrating a configuration example of a refrigeration cycler 200 according to a second embodiment. The refrigeration cycler 200 according to the second embodiment illustrated in FIG. 15 includes the direct-current power supply 100 described in the first embodiment, and an inverter 30 connected to the direct-current power supply 100. The refrigeration cycler 200 includes: a refrigeration cycle 150 in which a compressor 41 including an electric motor 40; a four-way valve 42; an outdoor heat exchanger 43; an expansion valve 44; and an indoor heat exchanger 45 are attached via a refrigerant pipe 46. The electric motor 40 is driven by the inverter 30.

Inside the compressor 41, a compression mechanism 47 that compresses a refrigerant and the electric motor 40 that operates the compression mechanism are provided. This forms the refrigeration cycle 150 that performs cooling and heating by a refrigerant circulating the compressor 41, the outdoor heat exchanger 43, and the indoor heat exchanger 45. Note that the refrigeration cycle 150 illustrated in FIG. 15 can be applied to devices including a refrigeration cycle, such as an air conditioner, a refrigerator, and a freezer.

The refrigeration cycler 200 according to the second embodiment includes the direct-current power supply 100 described in the first embodiment. As described above, the direct-current power supply 100 according to the first embodiment can suppress ringing noise that may occur due to a recovery current. This can provide an effect that, when the refrigeration cycler 200 according to the second embodiment is applied to an air conditioner and a refrigerator, for example, radiation noise radiated from these products can be made smaller than conventional ones. In addition, since the radiation noise can be made smaller than conventional ones, it is possible to obtain an effect of easily securing a margin with respect to an allowable value of the radiation noise.

The configuration illustrated in the above embodiment illustrates one example and can be combined with another known technique, and it is also possible to omit and change a part of the configuration without departing from the subject matter.

### REFERENCE SIGNS LIST

1 alternating-current power supply; 2 reactor; 3, 4, 5, 6 switching element; 7 smoothing capacitor; 8 load; 9 controller; 9a processor; 9b memory; 10 rectifier circuit; 11, 12 gate circuitry; 11a, 11b, 12a, 12b gate circuit; 14, 15 connection point; 21 HVIC; 22a, 22b gate-on resistor; 23a, 23b gate-off resistor; 24a, 24b diode; 25a, 25b resistor; 26a, 26b capacitor; 30 inverter; 40 electric motor; 41 compressor; 42 four-way valve; 43 outdoor heat exchanger; 44 expansion valve; 45 indoor heat exchanger; 46 refrigerant pipe; 47 compression mechanism; 50 first leg; 52 second leg; 100 direct-current power supply; 150 refrigeration cycle; 200 refrigeration cycler.

1. A direct-current power supply comprising:
a rectifier circuit in which first to fourth switching elements are bridge-connected;
a reactor connected between an alternating-current power supply and the rectifier circuit;
a first gate circuitry adapted to drive the first and second switching elements; and
a second gate circuitry adapted to drive the third and fourth switching elements, wherein
a connection point between the first switching element and the second switching element is connected to the alternating-current power supply via the reactor,
a connection point between the third switching element and the fourth switching element is connected to the alternating-current power supply without via the reactor, wherein
the first and second switching elements are subjected to switching control at a higher speed than the third and fourth switching elements,
a time during which the first gate circuitry turns on the first switching element is longer than a time during which the second gate circuitry turns on the third and fourth switching elements, and
a time during which the first gate circuitry turns on the second switching element is longer than a time during which the second gate circuitry turns on the third and fourth switching elements.

2. (canceled)

3. The direct-current power supply according to claim 1, wherein
the first gate circuitry includes a first gate circuit adapted to drive the first switching element and a second gate circuit adapted to drive the second switching element,
the second gate circuitry includes a third gate circuit adapted to drive the third switching element and a fourth gate circuit adapted to drive the fourth switching element,
each of the first to fourth gate circuits individually includes a gate-on resistor for gate-on and a gate-off resistor for gate-off of a switching element to be driven,
the gate-on resistor of the first gate circuit has a larger resistance value than the gate-on resistors of the third and fourth gate circuits, and
the gate-on resistor of the second gate circuit has a larger resistance value than the gate-on resistors of the third and fourth gate circuits.

4. A refrigeration cycler comprising:
the direct-current power supply according to claim 1;
an inverter connected to the direct-current power supply; and
a compressor including an electric motor to be driven by the inverter.

5. An air conditioner comprising the refrigeration cycler according to claim 4.

6. A refrigerator comprising the refrigeration cycler according to claim 4.

7. A refrigeration cycler comprising:
the direct-current power supply according to claim 3;
an inverter connected to the direct-current power supply; and
a compressor including an electric motor to be driven by the inverter.

8. An air conditioner comprising the refrigeration cycler according to claim 7.

9. A refrigerator comprising the refrigeration cycler according to claim 7.
